(19) United States
(12) Patent Application Publication
(10) Pub. No.: US 2012/0287055 A1
(43) Pub. Date: Nov. 15, 2012

(54) TOUCH APPARATUS AND TOUCH SENSING METHOD THEREOF

(75) Inventor: Jen-Wen Cheng, Tainan City (TW)

(73) Assignee: HIMAX TECHNOLOGIES LIMITED, Tainan City (TW)

(21) Appl. No.: 13/106,216

(22) Filed: May 12, 2011

(51) Int. Cl. G06F 3/041

(52) U.S. Cl. 345/173

(57) ABSTRACT

A touch apparatus and a touch sensing method thereof are provided. The touch sensing method includes the following steps. A first touch unit and a second touch unit are detected at different scan periods to obtain a first original signal and a second original signal. A reference signal is obtained according to the second original signal. A subtraction is performed on the first original signal and the reference signal, so as to eliminate low frequency noise of the first original signal.

### BACKGROUND

1. Field of the Invention

The invention relates to a touch apparatus and a touch sensing method thereof. Particularly, the invention relates to a touch apparatus capable of removing low frequency noises and a touch sensing method thereof.

2. Description of Related Art

A touch panel or a touch pad is generally integrated with a portable information product to achieve a more user-friendly user interface. Related panel manufacturers and IC design companies all take the touch panel technique as a major research and development project, and the related techniques and products have been applied to daily used electronic products such as information products of mobile phones, computers and personal digital assistants, etc.

The commonly used touch apparatus are divided into resistive touch apparatus and capacitive touch apparatus. A main operation principle of the capacitive touch apparatus is to sense an electrical characteristic of capacitance. When two layers of electrical conductors approach to each other without contacting, electric fields thereof are interacted to form a capacitance. Upper and lower surfaces of a touch panel structure are respectively conductive layers formed by intersected electrode lines. The user's finger is also an electrical conductor, and when the finger is put on the touch panel, a tiny capacitance is formed between the electrode lines of the touch panel and the finger, and a microprocessor can be used to detect a user's touch position according to a capacitance variation.

Since the capacitive touch apparatus is liable to be influenced by environment variations, for example, low frequency noises generated when the finger or other objects touch the touch apparatus, the electronic device may have misjudgement to cause waste of power.

### SUMMARY OF THE INVENTION

The invention is directed to a touch apparatus and a touch sensing method thereof, which can effectively remove low frequency noises in sensing signals, for example, finger noises or low frequency noises caused by other touch objects.

The invention provides a touch apparatus including a sensing line, a first touch unit, a second touch unit, a sensing module and a control unit. The sensing line is disposed on a touch panel. The first touch unit is disposed on the touch panel and is coupled to the sensing line, where the first touch unit is driven during a first line scan period. The second touch unit is disposed on the touch panel and is coupled to the sensing line, where the second touch unit is driven during a second line scan period. The sensing module is coupled to the sensing line, where the sensing module detects the first touch unit through the sensing line during the first line scan period to output a first original signal. The sensing module detects the second touch unit through the sensing line during the second line scan period to output a second original signal. The control unit is coupled to the sensing module, and obtains a reference signal according to the second original signal, and subtracts the reference signal from the first original signal to obtain a sensing signal of the first touch unit.

In an embodiment of the invention, the touch apparatus further includes a third touch unit disposed on the touch panel and coupled to the sensing line, where the third touch unit is driven during a third line scan period. The sensing module detects the third touch unit through the sensing line during the third line scan period to output a third original signal, and the control unit obtains the reference signal according to the second original signal and the third original signal.

In an embodiment of the invention, the control unit calculates an average or a weighted average of the second original signal and the third original signal to serve as the reference signal.

In an embodiment of the invention, the touch apparatus further includes a plurality of third touch units disposed on the touch panel and coupled to the sensing line. The first touch unit, the second touch unit and the third touch units are respectively driven during different line scan periods. The sensing module respectively detects the third touch units through the sensing line during the different line scan periods to output a plurality of third original signals. The control unit obtains the reference signal according to the second original signal and the third original signals.

In an embodiment of the invention, the control unit calculates an average or a weighted average of the second original signal and the third original signals to serve as the reference signal.

In an embodiment of the invention, the first touch unit includes a first sensing capacitor. One end of the first sensing capacitor is coupled to a first scan line, and another end thereof is coupled to the sensing line. The second touch unit includes a second sensing capacitor. One end of the second sensing capacitor is coupled to a second scan line, and another end thereof is coupled to the sensing line.

In an embodiment of the invention, the sensing module includes a first capacitor and an operation amplifier. An inverting input terminal of the operation amplifier is coupled to a first end of the first capacitor and the sensing line, a non-inverting input terminal of the operation amplifier is coupled to a reference voltage, and an output terminal of the operation amplifier is coupled to a second end of the first capacitor and the control unit.

The invention provides a method for eliminating noise of a touch apparatus, where the touch apparatus includes a sensing line, a first touch unit and a second touch unit. The method for eliminating noise of the touch apparatus includes the following steps. The first touch unit is driven during a first line scan period. The first touch unit is detected through the sensing line during the first line scan period to obtain a first original signal. The second touch unit is driven during a second line scan period. The second touch unit is detected through the sensing line during the second line scan period to obtain a second original signal. A reference signal is obtained according to the second original signal. The reference signal is subtracted from the first original signal to obtain a sensing signal of the first touch unit.

In an embodiment of the invention, the first touch unit and the second touch unit are adjacent to each other.

In an embodiment of the invention, the first line scan period and the second line scan period are adjacent to each other in timing.

In an embodiment of the invention, the reference signal is the second original signal.

In an embodiment of the invention, the touch apparatus further includes a third touch unit, and the method for eliminating noise of the touch apparatus further includes following steps. The third touch unit is driven during a third line scan period. The third touch unit is detected through the sensing line during the third line scan period to obtain a third original signal. The reference signal is obtained according to the second original signal and the third original signal.

In an embodiment of the invention, the step of obtaining the reference signal according to the second original signal and the third original signal includes calculating an average or a weighted average of the second original signal and the third original signal. The average or the weighted average is taken as the reference signal.

In an embodiment of the invention, the touch apparatus further includes a plurality of third touch units, and the method for eliminating noise of the touch apparatus further includes following steps. The third touch units are respectively driven during different line scan periods. The third touch units are respectively detected through the sensing line during the different line scan periods to obtain a plurality of third original signals. The reference signal is obtained according to the second original signal and the third original signals.

In an embodiment of the invention, the step of obtaining the reference signal according to the second original signal and the third original signals includes calculating an average or a weighted average of the second original signal and the third original signals. The average or the weighted average is taken as the reference signal.

In an embodiment of the invention, the first touch unit includes a first sensing capacitor, and the second touch unit includes a second sensing capacitor.

According to the above descriptions, the touch units on the scan line are detected during different scan periods to obtain the first original signal and the second original signal, and the reference signal is obtained according to the second original signal. Then, the reference signal is subtracted from the first original signal to eliminate the low frequency noise of the first original signal, so as to obtain the sensing signal of the first touch unit. In this way, correctness of determining the touch position is improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a touch apparatus according to an embodiment of the invention.

FIG. 2 is a waveform diagram of driving signals of scan lines according to an embodiment of the invention.

FIG. 3 is a schematic diagram of a touch apparatus according to another embodiment of the invention.

FIG. 4 is a flowchart illustrating a touch sensing method of a touch apparatus according to an embodiment of the invention.

### DETAILED DESCRIPTION OF DISCLOSED EMBODIMENTS

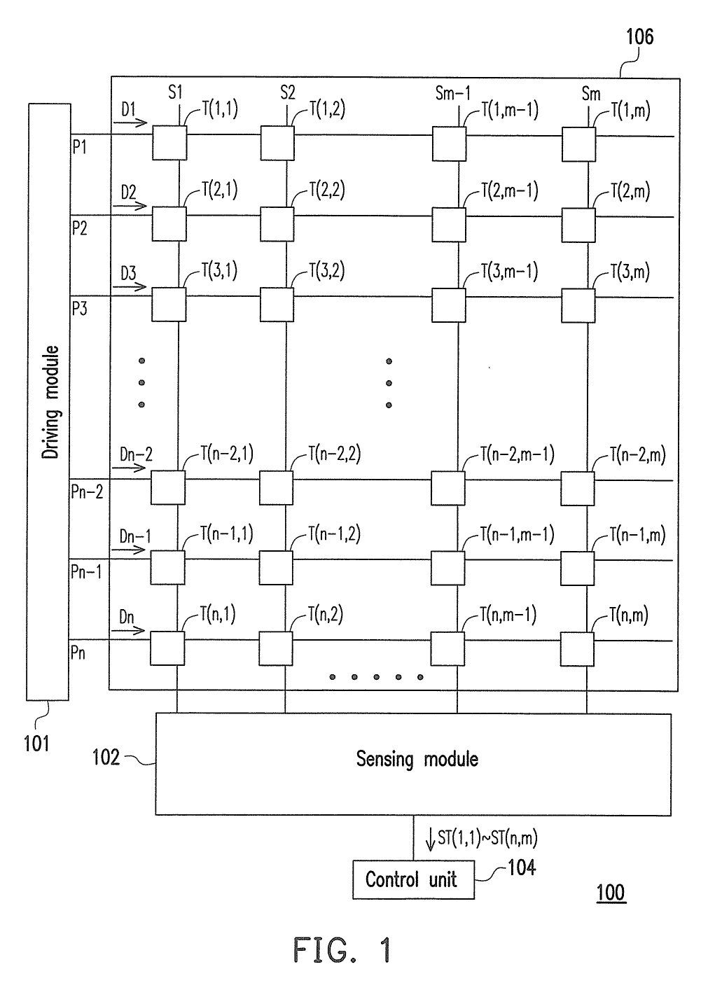

FIG. 1 is a schematic diagram of a touch apparatus according to an embodiment of the invention. Referring to FIG. 1, the touch apparatus 100 includes n scan lines P1-Pn, m sensing lines S1-Sm, a plurality of touch units T(x,y), a driving module 101, a sensing module 102 and a control unit 104. The scan lines P1-Pn and the sensing lines S1-Sm are disposed on a touch panel 106, and the touch unit T(x,y) represents a touch unit located at an intersection of an x^{th} scan line and a y^{th} sensing line, where n, m, x and y are positive integers, and 1≦x≦n, 1≦y≦m. Moreover, the sensing module 102 is coupled to the sensing lines S1-Sm and the control unit 104.

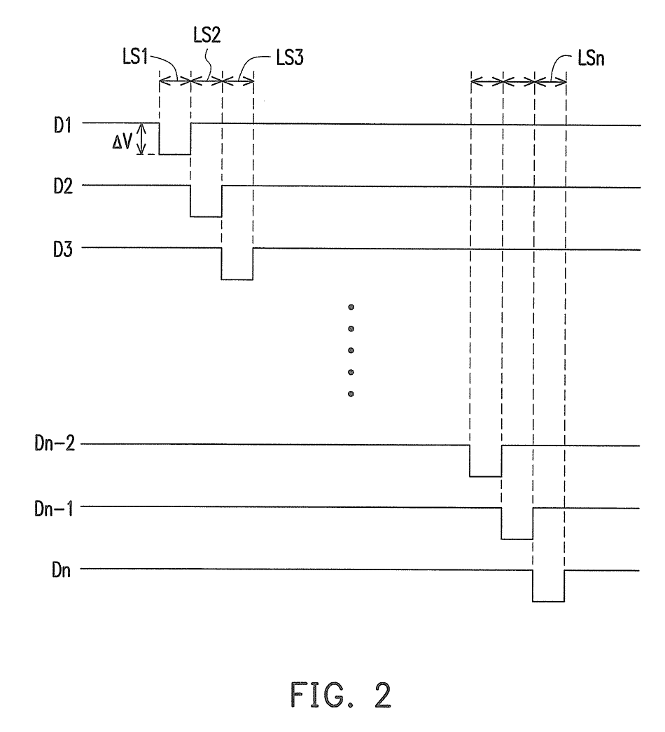

The touch units T(x,1) on the sensing line S1 may respectively receive driving signals D1-Dn and can be driven during different line scan periods. For example, FIG. 2 is a waveform diagram of driving signals of the scan lines P1-Pn according to an embodiment of the invention. Referring to FIG. 2, a low level period of each of the driving signals D1-Dn corresponds to the line scan period of each of the scan lines P1-Pn, for example, the low level period of the driving signal D1 is a line scan period LS1 of the scan line P1, the low level period of the driving signal D2 is a line scan period LS2 of the scan line P2, and the others are deduced by analogy. All of the touch units T(1,1)-T(1,m) on the scan line P1 are driven (or turned on) during the line scan period LS1 (i.e. the low voltage level period of the driving signal D1). All of the touch units T(2,1)-T(2,m) on the scan line P2 are driven (or turned on) during the line scan period LS2 (i.e. the low voltage level period of the driving signal D2). Similarly, the touch units T(31)-T(n,m) on the scan line P3-Pn are respectively driven under control of the driving signals D3-Dn. The sensing module 102 detects the sensing lines S1-Sm, and outputs a plurality of original signals ST(x,1)-ST(x,m) during the line scan periods LS1-LSn of the scan lines P1-Pn.

For simplicity's sake, the sensing line S1 is taken as an example to describe a detailed implementation of the present embodiment, and descriptions of the other sensing lines S2-Sm are the same to the related description of the sensing line S1. The sensing module 102 respectively detects the touch units T1(1,1), T(2,1), . . . , T(n−2,1), T(n−1,1) and T(n,1) on the scan lines P1-Pn through the sensing line S1 during the line scan periods of each of the scan lines P1-Pn, so as to output a plurality of original signals ST(x,1). For example, the sensing module 102 detects the touch unit T1(1,1) through the sensing line S1 during the line scan period LS1 of the scan line P1 to output an original signal ST(1,1), and detects the touch unit T1(2,1) through the sensing line S1 during the line scan period LS2 of the scan line P2 to output an original signal ST(2,1). Similarly, the sensing module 102 respectively detects the touch units T1(3,1)-T(n,1) through the sensing line S1 during the line scan periods LS3-LSn of the scan lines P3-Pn to output corresponding original signals ST(3,1)-ST(n,1).

The control unit 104 receives the original signals ST(1,1)-ST(n,1) from the sensing module 102 and obtains a reference signal according to the original signals ST(1,1)-ST(n,1), for example, selects one of the original signals ST(1,1)-ST(n,1) to serve as the reference signal. In the present embodiment, the second original signal ST(2,1) is selected to serve as the reference signal. After the reference signal is obtained, the control unit 104 further subtracts the reference signal (i.e. the second original signal ST(2,1)) from the first original signal ST(1,1) to eliminate low frequency noise of the first original signal ST(1,1), so as to obtain a sensing signal of the touch unit T(1,1). Similarly, sensing signals of the other touch units T(2,1)-T(n,1) can be obtained according to the same method, which are not repeated herein.

In the present embodiment, the control unit 104 can perform subtraction on two original signals adjacent to each other in timing to achieve noise cancellation. For example, the line scan periods LS1 and LS2 are adjacent in timing, so that the original signal ST(2,1) of the line scan period LS2 can serve as the reference signal of the original signal ST(1,1) of the line scan period LS1. The control unit 104 can subtract the reference signal from the first original signal ST(1,1) of the line scan period LS1 (i.e. ST(1,1)-ST(2,1)) to obtain the sensing signal of the touch unit T(1,1). Deduced by analogy, the sensing signal of the touch unit T(2,1) is ST(2,1)-ST(3,1), and the sensing signal of the touch unit T(n−2,1) is ST(n−2,1)-ST(n−1,1). In other embodiments, the first original signal ST(1,1) can serve as the reference signal of the second original signal ST(2,1). The control unit 104 can subtract the reference signal from the second original signal ST(2,1) (i.e. ST(2,1)-ST(1,1)) to obtain the sensing signal of the touch unit T(2,1). Deduced by analogy, the sensing signal of the touch unit T(n−1,1) is ST(n−1,1)-ST(n−2,1), and the sensing signal of the touch unit T(n,1) is ST(n,1)-ST(n−1,1).

Alternatively, the control unit 104 can perform subtraction on original signals of two touch units spatially adjacent to each other to achieve noise cancellation. For example, the touch units T(1,1) and T(2,1) are adjacent to each other in space, so that the original signal ST(2,1) of the touch unit T(2,1) can serve as the reference signal of the touch unit T(1,1). The control unit 104 can subtract the reference signal from the first original signal ST(1,1) of the touch unit T(1,1) (i.e. ST(1,1)-ST(2,1)) to obtain the sensing signal of the touch unit T(1,1). Deduced by analogy, the sensing signal of the touch unit T(2,1) is ST(2,1)-ST(3,1), and the sensing signal of the touch unit T(n−2,1) is ST(n−2,1)-ST(n−1,1). In other embodiments, the original signal ST(1,1) of the touch unit T(1,1) can serve as the reference signal of the touch unit T(2,1). The control unit 104 can subtract the reference signal from the original signal ST(2,1) of the touch unit T(2,1) (i.e. ST(2,1)-ST(1,1)) to obtain the sensing signal of the touch unit T(2,1). Deduced by analogy, the sensing signal of the touch unit T(n−1,1) is ST(n−1,1)-ST(n−2,1), and the sensing signal of the touch unit T(n,1) is ST(n,1)-ST(n−1,1).

Moreover, the method of obtaining the sensing signal of the touch unit T(x,1) on the sensing line S1 can be used to obtain sensing signals of the touch units T(x,2)-T(x,m) on the other sensing lines S2-Sm, for example, the sensing module 102 can detect the touch units T(x,2)-T(x,m) on the sensing lines S2-Sm to output a plurality of the original signals ST(x,2)-ST(x,m), and accordingly obtain the corresponding reference signals and the sensing signals, details thereof are not repeated.

After the low frequency noise of the original signal of each of the touch units is removed to obtain the corresponding sensing signal, a high frequency noise in the sensing signal can be filtered by a low pass filter, or a digital signal processor (DSP) filter (not shown). In this way, the control unit 104 can obtain a correct touch position according to the sensing signal removed with the high frequency noise and the low frequency noise.

It should be noticed that the waveforms of the driving signals D1-Dn are not limited to the driving waveforms shown in FIG. 2, i.e. the scan lines P1-Pn are not limited to be enabled in a sequence of P1, P2, . . . , Pn−2, Pn−1 and Pn. For example, the odd scan lines (for example, P1, P3, . . . ) can be first driven/enabled, and then the even scan lines (for example, P2, P4, . . . ) are driven/enabled. In this case, the original signal ST(1,1) of the touch unit T(1,1) and the original signal ST(3,1) of the touch unit T(3,1) are adjacent to each other in timing, so that the original signal ST(3,1) can serve as the reference signal of the original signal ST(1,1). The control unit 104 can subtract the reference signal from the original signal of the touch unit T(1,1) (i.e. ST(1,1)-ST(3,1)) to obtain the sensing signal of the touch unit T(1,1). The sensing signals of the other touch units can be deduced by analogy. In other embodiments, the first original signal ST(1,1) can serve as the reference signal of the third original signal ST(3,1). The control unit 104 can subtract the reference signal from the third original signal ST(3,1) (i.e. ST(3,1)-ST(1,1)) to obtain the sensing signal of the touch unit T(2,1).

Alternatively, the reference signal can be obtained according to original signals generated during two or more line scan periods. For example, the control unit 104 calculates an average or a weighted average of the original signals ST(2,1)-ST(3,1) corresponding to the touch units T(2,1)-T(3,1) to serve as the reference signal of the touch unit T(1,1), so as to obtain the sensing signal of the touch unit T(1,1), for example, ST(1,1)-[ST(2,1)+ST(3,1)]/2, and the sensing signal of the touch unit T(n−2,1) is ST(n−2,1)-[ST(n−1,1)+ST(n,1)]/2. Alternatively, the control unit 104 calculates an average or a weighted average of the original signals ST(1,1)-ST(2,1) corresponding to the touch units T(1,1)-T(2,1) to serve as the reference signal of the touch unit T(3,1), so as to obtain the sensing signal of the touch unit T(3,1), for example, ST(3,1)-[ST(1,1)+ST(2,1)]/2, and the sensing signal of the touch unit T(n,1) is ST(n,1)-[ST(n−2,1)+ST(n−1,1)]/2.

In the other embodiments, the control unit 104 calculates an average or a weighted average of the original signals of all of the touch units of the same sensing line to obtain the reference signal. For example, the control unit 104 calculates an average or a weighted average of the original signals ST(2,1)-ST(n,1) of the touch units T(2,1)-T(n,1) to serve as the reference signal of the touch unit T(1,1). Alternatively, the control unit 104 calculates an average or a weighted average of the original signals ST(1,1)-ST(n,1) to serve as the reference signal of all of the touch units T(1,1)-T(n,1) of the sensing line S1.

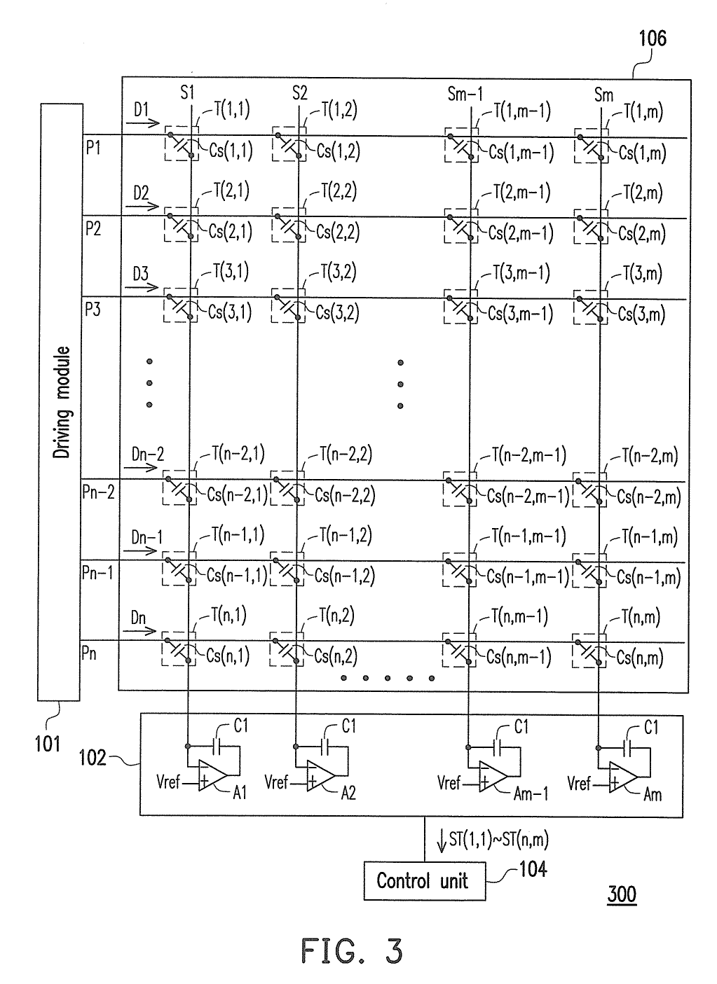

FIG. 3 is a schematic diagram of a touch apparatus according to another embodiment of the invention. Related descriptions of FIG. 1 and FIG. 2 can be referred for the present embodiment. Referring to FIG. 3, in the touch apparatus 300 of the present embodiment, the touch units T(x,y) can be respectively implemented by sensing capacitors Cs(x,y), where one end of each of the sensing capacitors Cs(x,y) is coupled to the corresponding scan line, and another end thereof is coupled to the corresponding sensing line. For example, one end of the sensing capacitor Cs(1,1) is coupled to the scan line P1, and another end thereof is coupled to the sensing line S1. One end of the sensing capacitor Cs(2,1) is coupled to the scan line P2, and another end thereof is coupled to the sensing line S1, and the others are deduced by analogy.

Moreover, the sensing module 102 includes a plurality of first capacitors C1 and a plurality of operation amplifiers A1-Am. Inverting input terminals of the operation amplifiers A1-Am are respectively coupled to the sensing lines S1-Sm and first ends of the corresponding first capacitors C1, non-inverting input terminals of the operation amplifiers A1-Am are coupled to a reference voltage Vref, and output terminals of the operation amplifiers A1-Am are coupled to second ends of the corresponding first capacitors C1 and the control unit 104.

It is assumed that the driving signals D1-Dn of the present embodiment are the driving signals D1-Dn shown in FIG. 2, where the low level periods of the driving signals D1-Dn are the line scan periods of the scan lines, and a difference of high and low voltage levels of each of the driving signals D1-Dn is ΔV. As shown in FIG. 3, it is assumed that a touch position of the user's finger on the touch panel 106 is the intersection of the scan line Pn−2 and the sensing line Sm, i.e. the touch unit T(n−2,m). A capacitance difference caused by the user's finger on the sensing capacitor Cs (n−2,m) of the touch unit T(n−2,m) is ΔC.

The operation amplifiers A1-Am respectively detect the touch units of the corresponding scan lines at different line scan periods to output a plurality of original signals. It is assumed that the capacitance of each of the sensing capacitors is Cs. For example, when the scan line Pn−2 is enabled, the operation amplifiers A1-Am output the original signals ST(n−2,1)-ST(n−2,m) of the touch units T(n−2,1)-T(n−2,m) to the control unit 104, and voltage values thereof are respectively V(n−2,1)-V(n−2,m), where the voltage value V(n−2,m−1) of the original signal ST(n−2,m−1) can be represented by a following equation:

$$V ( n - 2 , m - 1 ) = \frac{Cs}{C 1} Δ V + VN ( n - 2 , m - 1 )$$

Where, VN(n−2,m−1) is a noise voltage in the original signal ST(n−2,m−1) output by the operation amplifier Am−1 as the operation amplifier Am−1 detects the touch unit T(n−2,m−1). Similarly, the voltage value V(n−2,m) of the original signal ST(n−2,m) can be represented by a following equation:

$$V ( n - 2 , m ) = \frac{Cs + Δ C}{C 1} Δ V + V N ( n - 2 , m ) + VFN$$

Where, VN(n−2,m) is a noise voltage in the original signal ST(n−2,m) output by the operation amplifier Am as the operation amplifier Am detects the touch unit T(n−2,m), and VFN is a noise voltage caused by the finger that touches the touch panel 106.

Moreover, when the scan line Pn−1 is enabled, the operation amplifiers A1-Am output the original signals ST(n−1,1)-ST(n−1,m) of the touch units T(n−1,1)-T(n−1,m), and voltage values of the original signals ST(n−1,1)-ST(n−1,m) are respectively V(n−1,1)-V(n−1,m), where the voltage value V(n−1,m−1) of the original signal ST(n−1,m−1) can be represented by a following equation:

$$V ( n - 1 , m - 1 ) = \frac{Cs}{C 1} Δ V + VN ( n - 1 , m - 1 )$$

Where, VN(n−1,m−1) is a noise voltage in the original signal ST(n−1,m−1) output by the operation amplifier Am−1 as the operation amplifier Am−1 detects the touch unit T(n−1,m−1). Similarly, when the scan line Pn−1 is enabled, the voltage value V(n−1,m) of the original signal ST(n−1,m) can be represented by a following equation:

$$V ( n - 1 , m ) = \frac{Cs}{C 1} Δ V + VN ( n - 1 , m ) + VFN$$

Where, VN(n−1,m) is a noise voltage in the original signal ST(n−1,m) output by the operation amplifier Am as the operation amplifier Am detects the touch unit T(n−1,m), and VFN is a noise voltage caused by the finger that touches the touch panel 106.

In the present embodiment, the original signal ST(n−1,m) of the same sensing line Sm can be set as the reference signal of the original signal ST(n−2,m). The control unit 104 can subtract the reference signal ST(n−1,m) from the original signal ST(n−2,m) to eliminate the low frequency noise of the original signal ST(n−2,m). Deduced by analogy, the control unit 104 can subtract the reference signals ST(n−1,1)-ST(n−1,m−1) from the original signals ST(n−2,1)-ST(n−2,m−1) to eliminate the low frequency noises of the original signals ST(n−2,1)-ST(n−2,m−1). For example, in the present embodiment, a voltage value ΔV(n−2,m−1) of the sensing signal ST'(n−2,m−1) removed with the low frequency noise can be represented by a following equation:

$$\begin{matrix}Δ V ( n - 2 , m - 1 ) = V ( n - 2 , m - 1 ) - V ( n - 1 , m - 1 ) \\ = \frac{Cs}{C 1} Δ V + VN ( n - 2 , m - 1 ) - \frac{Cs}{C 1} Δ V - VN ( n - 1 , m - 1 ) \\ = VHN ( n - 2 , m - 1 )\end{matrix}$$

Where, VHN(n−2,m−1) is a high frequency noise voltage in the sensing signal ST'(n−2,m−1) removed with the low frequency noise. Moreover, a voltage value ΔV(n−2,m) of the sensing signal ST′(n−2,m) removed with the low frequency noise can be represented by a following equation:

$$\begin{matrix}Δ V ( n - 2 , m ) = V ( n - 2 , m ) - V ( n - 1 , m ) \\ = \frac{Cs + Δ C}{C 1} Δ V + VN ( n - 2 , m ) + VFN - \frac{Cs}{C 1} Δ V - \\ VN ( n - 1 , m ) - VFN \\ = \frac{Δ C}{C 1} Δ V + VHN ( n - 2 , m )\end{matrix}$$

Where

$$\frac{Δ C}{C 1} Δ V$$

is a sensing voltage difference caused by the finger that touches the touch panel 106, and VHN(n−2,m) is a high frequency noise voltage in the original signal ST(n−2,m) removed with the low frequency noise. The noise voltage VFN (low frequency noise) in the original signal ST(n−2,m) caused by the finger can be removed.

Similarly, the sensing signals of the other touch units can be obtained according to the same method, and detailed descriptions thereof are not repeated.

After the control unit 104 substrates the reference signal from the corresponding original signal, only the high frequency noise voltage and the sensing voltage difference caused by the finger that touches the touch panel 106 are remained in the obtained sensing signal, where the high frequency noise voltage can be easily filtered by using a low pass filter or a DSP filter (not shown) of the conventional technique, so that only the sensing voltage difference caused by the finger that touches the touch panel 106 is remained in the sensing signal. In this way, misjudgement of the touch position due to that the sensing result is influenced by the noise voltage can be avoided.

It should be noticed that the touch unit T1 is not limited to be the sensing capacitor Cs, namely, the touch panel 106 is not limited to be the capacitive touch panel, which can also be other types of the touch panel, for example, a resistive touch panel.

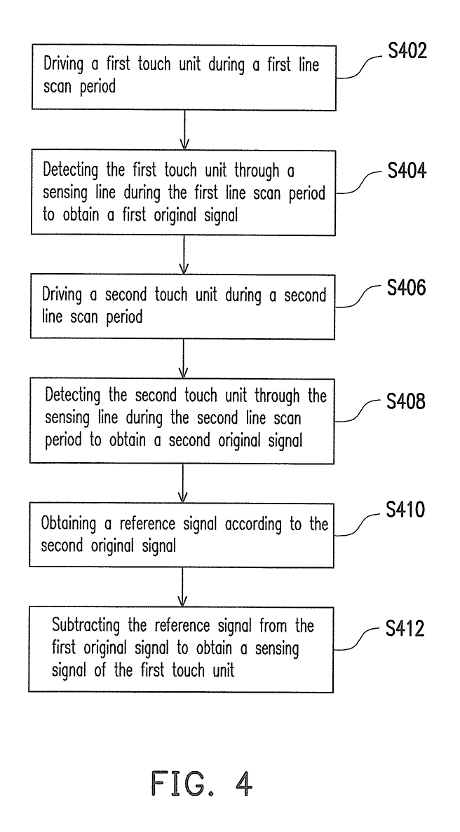

FIG. 4 is a flowchart illustrating a touch sensing method of a touch apparatus according to an embodiment of the invention. Referring to FIG. 4, the touch sensing method is adapted to the aforementioned touch apparatus 100, which includes following steps. First, a first touch unit (for example, the touch unit T(1,1)) is driven during a first line scan period (for example, the line scan period of the driving signal D1) (step S402). Then, the first touch unit is detected through the sensing line (for example, the sensing line S1) during the first line scan period to obtain a first original signal (for example, the original signal ST(1,1)) (step S404), where the touch unit is, for example, a sensing capacitor. Then, a second touch unit (for example, a touch unit T(2,1)) is driven during a second line scan period (for example, the line scan period of the driving signal D2) (step S406), where the reference signal is, for example, an original signal output by the sensing module 102 during a certain line scan period, or an original signal output by the sensing module 102 during an adjacent previous or next line scan period, or an average or a weighted average of the original signals generated during different line scan periods. Then, the second touch unit is detected through the sensing line during the second line scan period to obtain a second original signal (for example, the original signal ST(2,1)) (step S408). Then, a reference signal is obtained according to the second original signal (step S410). Finally, the reference signal is subtracted from the first original signal to obtain a sensing signal of the first touch unit (step S412).

In summary, the reference signal is obtained according to the original signals obtained at different line scan periods, and the reference signal is subtracted from each of the original signals to eliminate the low frequency noise of the original signal, so as to obtain the corresponding sensing signal. In this way, only the high frequency noise voltage and the sensing voltage difference caused by the finger that touches the touch panel are remained in the obtained sensing signal, where the high frequency noise voltage can be easily filtered by using a low pass filter or a DSP filter of the conventional technique, so that only the sensing voltage difference caused by the finger that touches the touch panel is remained in the sensing signal. Therefore, the sensing result is not influenced by the noise voltage, and correctness of determining the touch position is improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch apparatus, comprising:
a sensing line, disposed on a touch panel;
a first touch unit, disposed on the touch panel and coupled to the sensing line, wherein the first touch unit is driven during a first line scan period;
a second touch unit, disposed on the touch panel and coupled to the sensing line, wherein the second touch unit is driven during a second line scan period;
a sensing module, coupled to the sensing line, wherein the sensing module detects the first touch unit through the sensing line during the first line scan period to output a first original signal, and the sensing module detects the second touch unit through the sensing line during the second line scan period to output a second original signal; and
a control unit, coupled to the sensing module, for obtaining a reference signal according to the second original signal, and subtracting the reference signal from the first original signal to obtain a sensing signal of the first touch unit.

2. The touch apparatus as claimed in claim 1, wherein the first touch unit and the second touch unit are adjacent to each other.

3. The touch apparatus as claimed in claim 1, wherein the first line scan period and the second line scan period are adjacent to each other in timing.

4. The touch apparatus as claimed in claim 1, wherein the reference signal is the second original signal.

5. The touch apparatus as claimed in claim 1, further comprising:
a third touch unit, disposed on the touch panel and coupled to the sensing line, wherein the third touch unit is driven during a third line scan period,
wherein the sensing module detects the third touch unit through the sensing line during the third line scan period to output a third original signal, and the control unit obtains the reference signal according to the second original signal and the third original signal.

6. The touch apparatus as claimed in claim 5, wherein the control unit calculates an average or a weighted average of the second original signal and the third original signal to serve as the reference signal.

7. The touch apparatus as claimed in claim 1, further comprising:
a plurality of third touch units, disposed on the touch panel and coupled to the sensing line,
wherein the first touch unit, the second touch unit and the third touch units are respectively driven during different line scan periods, the sensing module respectively detects the third touch units through the sensing line during the different line scan periods to output a plurality of third original signals, and the control unit obtains the reference signal according to the second original signal and the third original signals.

8. The touch apparatus as claimed in claim 7, wherein the control unit calculates an average or a weighted average of the second original signal and the third original signals to serve as the reference signal.

9. The touch apparatus as claimed in claim 1, wherein the first touch unit comprises a first sensing capacitor, one end of the first sensing capacitor is coupled to a first scan line, and another end thereof is coupled to the sensing line, the second touch unit comprises a second sensing capacitor, one end of the second sensing capacitor is coupled to a second scan line, and another end thereof is coupled to the sensing line.

10. The touch apparatus as claimed in claim 1, wherein the sensing module comprises:
a first capacitor; and
an operation amplifier, having an inverting input terminal coupled to a first end of the first capacitor and the sensing line, a non-inverting input terminal coupled to a reference voltage, and an output terminal coupled to a second end of the first capacitor and the control unit.

11. A method for eliminating noise of a touch apparatus, wherein the touch apparatus comprises a sensing line, a first touch unit and a second touch unit, the method for eliminating noise of the touch apparatus comprising:
driving the first touch unit during a first line scan period;
detecting the first touch unit through the sensing line during the first line scan period to obtain a first original signal;
driving the second touch unit during a second line scan period;
detecting the second touch unit through the sensing line during the second line scan period to obtain a second original signal;
obtaining a reference signal according to the second original signal; and
subtracting the reference signal from the first original signal to obtain a sensing signal of the first touch unit.

12. The method for eliminating noise of the touch apparatus as claimed in claim 11, wherein the first touch unit and the second touch unit are adjacent to each other.

13. The method for eliminating noise of the touch apparatus as claimed in claim 11, wherein the first line scan period and the second line scan period are adjacent to each other in timing.

14. The method for eliminating noise of the touch apparatus as claimed in claim 11, wherein the reference signal is the second original signal.

15. The method for eliminating noise of the touch apparatus as claimed in claim 11, wherein the touch apparatus further comprises a third touch unit, and the method for eliminating noise of the touch apparatus further comprises:
driving the third touch unit during a third line scan period;
detecting the third touch unit through the sensing line during the third line scan period to obtain a third original signal; and
obtaining the reference signal according to the second original signal and the third original signal.

16. The method for eliminating noise of the touch apparatus as claimed in claim 15, wherein the step of obtaining the reference signal according to the second original signal and the third original signal comprises:
calculating an average or a weighted average of the second original signal and the third original signal; and
taking the average or the weighted average as the reference signal.

17. The method for eliminating noise of the touch apparatus as claimed in claim 11, wherein the touch apparatus further comprises a plurality of third touch units, and the method for eliminating noise of the touch apparatus further comprises:
respectively driving the third touch units during different line scan periods;
respectively detecting the third touch units through the sensing line during the different line scan periods to obtain a plurality of third original signals; and
obtaining the reference signal according to the second original signal and the third original signals.

18. The method for eliminating noise of the touch apparatus as claimed in claim 17, wherein the step of obtaining the reference signal according to the second original signal and the third original signals comprises:
calculating an average or a weighted average of the second original signal and the third original signals; and
taking the average or the weighted average as the reference signal.

19. The method for eliminating noise of the touch apparatus as claimed in claim 11, wherein the first touch unit comprises a first sensing capacitor, and the second touch unit comprises a second sensing capacitor.
